(19) United States
(12) Patent Application Publication
(10) Pub. No.: US 2026/0149318 A1
(43) Pub. Date: May 28, 2026

(54) THREE-PHASE EXTERNAL ROTOR MOTOR AND METHOD FOR ASSEMBLING A STATOR FOR A THREE-PHASE EXTERNAL ROTOR MOTOR

(71) Applicant: BorgWarner Inc., Auburn Hills, MI (US)

(72) Inventors: Jan Schmolke, Kirchheimbolanden (DE); Georg Scholz, Wöllstein (DE); Birgit Kullmann, Weisenheim / Sand (DE)

(21) Appl. No.: 19/381,092

(22) Filed: Nov. 6, 2025

(30) Foreign Application Priority Data
Nov. 27, 2024 (DE) 10 2024 135 010.5

(51) Int. Cl. H02K 1/16; H02K 1/2786; H02K 15/0273

(52) U.S. Cl. CPC H02K 1/16; H02K 1/2786; H02K 15/0273; H02K 2215/00

(57) ABSTRACT

A three-phase external rotor motor is described with a rotor and a stator surrounding the rotor, wherein the rotor has permanent magnets and the stator comprises a stack with an annular cross-section. End caps arranged at both ends of the sheet stack and stator windings arranged in slots on a radial outer side. The stator has grooves on a radial inner side, which run in a straight line in the axial direction from one of the two end caps over the sheet stack to the other end cap. In addition, a method for assembling a stator for a three-phase external rotor motor is described.

### CROSS REFERENCE TO RELATED APPLICATIONS

This application claims priority to DE 10 2024 135 010.5 filed Nov. 27, 2024, the disclosure of which is hereby incorporated herein by reference.

### BACKGROUND

The present disclosure relates to a three-phase electric motor, more specifically an external rotor motor.

In three-phase external rotor motors, end caps are commonly used, which are arranged at both axial ends of a stator laminated core in order to facilitate the wire routing for forming the windings of the three phases, in particular to ensure by means of a clean winding pattern a robust manufacturing process without rejects. To prevent incorrect connections from being created with the phase windings, the end caps must be positioned relative to each other in the correct rotational angle position.

### SUMMARY

The present disclosure provides a way in which the assembly of a stator for a three-phase external rotor motor can be facilitated.

This task is solved by an external rotor motor with the features described herein and by a method according to the present disclosure. Advantageous further refinements are also described in the present disclosure.

The stator of an external rotor motor according to an embodiment described herein has grooves on a radial inner side, which run from one of the two end caps over the stator laminated core to the opposite end cap. During assembly, pins of a tool can engage in these grooves of the stator laminated core and the endcaps, thus ensuring correct positioning of the two end caps relative to each other and centring on the laminated core.

An advantageous further refinement provides that the number of grooves on the inner side of the stator is an integer multiple of the number 3 and that the grooves are evenly distributed in the circumferential direction. In a three-phase electric motor, the windings of the individual phases are arranged in a corresponding rotational symmetry, i.e. a rotation of 120° results in an identical configuration. If the grooves reflect the rotational symmetry of the windings of the individual phases, assembly is simplified because the number of correct configurations in which the pins of the tool can engage in the grooves is increased accordingly.

A further advantageous refinement provides that the grooves have the shape of a circular segment at least in the area of their base. In this way, pins with a circular cross-section can easily engage in the grooves during assembly and position the end caps relative to each other and centre them on the sheet metal stack. This has the advantage of avoiding plastic deformation of the end cap. Pins with a circular cross-section are available at low cost for a corresponding tool. However, the method can also be carried out with differently shaped pins and the grooves can be shaped accordingly.

### BRIEF DESCRIPTION OF THE DRAWINGS

Further details and advantages are explained in an illustrative embodiment with reference to the accompanying drawings. Identical and corresponding components are marked with matching reference symbols in the various drawings.

FIG. 1 shows a sectional view of an embodiment of an electric motor according to the invention;

FIG. 2 shows the stator of the electric motor shown in FIG. 1;

FIG. 3 is a detailed view of FIG. 2; and

FIG. 4 shows a schematic representation of the assembly of stator components.

Although the exemplification set out herein illustrates an embodiment of the invention, in one form, the embodiment disclosed below is not intended to be exhaustive or to be construed as limiting the scope of the invention to the precise form disclosed.

### DETAILED DESCRIPTION

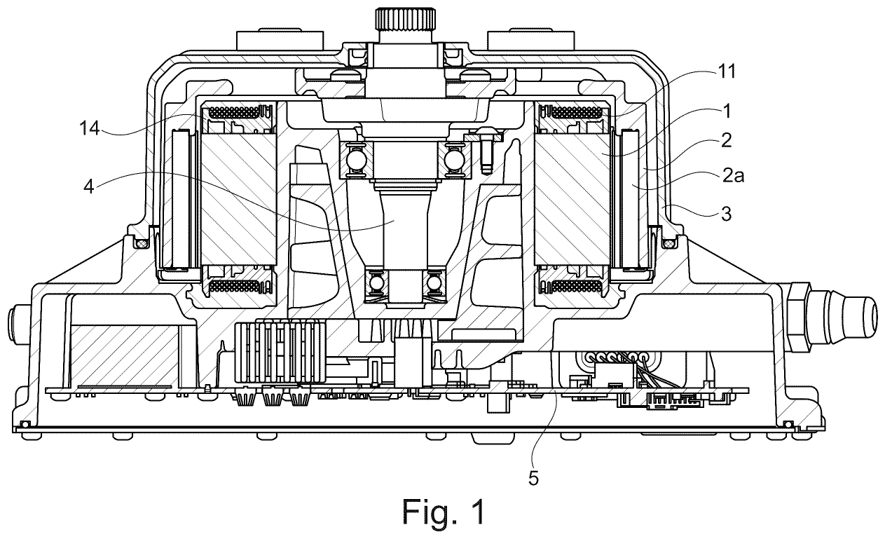

FIG. 1 shows a sectional view of an electric motor. This electric motor is a three-phase external rotor motor with a stator 1, a rotor 2 surrounding the stator 1 radially and a housing 3. The rotor 2 is coupled to a shaft 4, which is arranged in an interior space surrounded by the stator 1. The rotor 2 carries permanent magnets 2a, which interact with windings 11 of the stator 1. The power supply to the stator windings 11 is controlled by control electronics 5.

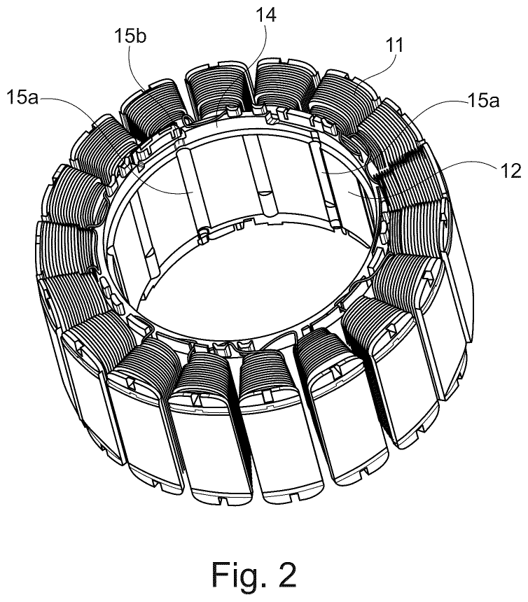

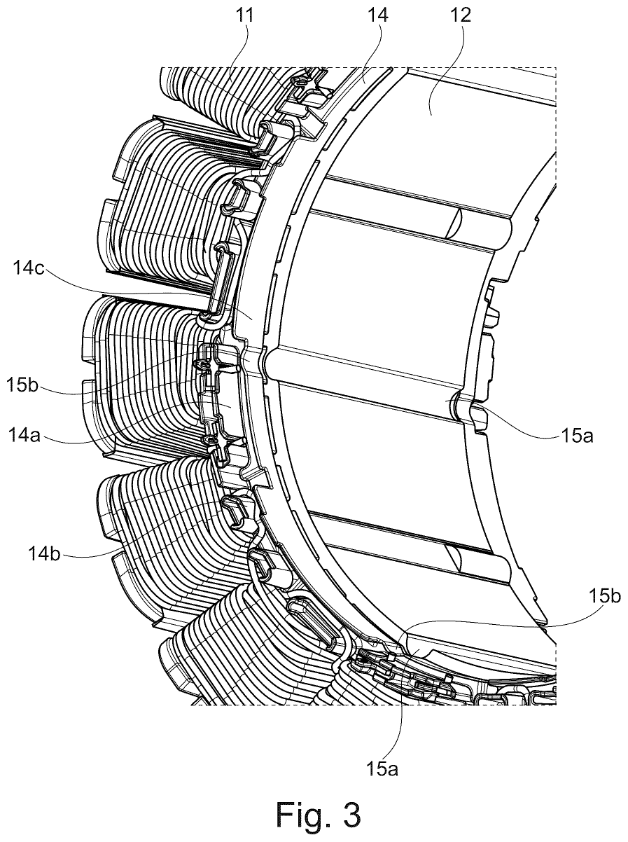

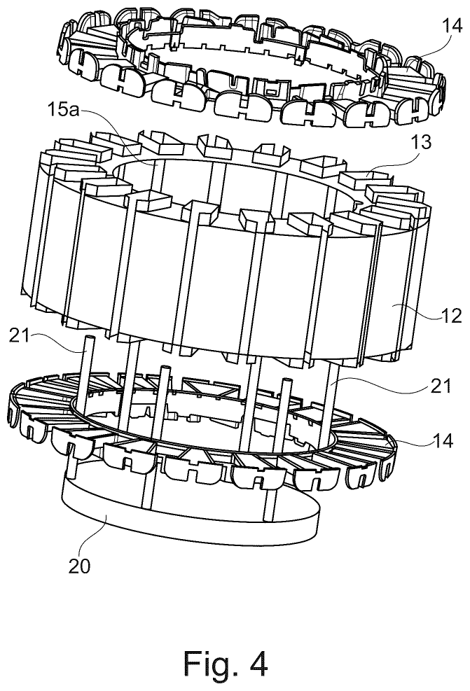

FIGS. 2 and 3 show the stator 1 of this electric motor. FIG. 4 schematically shows a step in the assembly of components of the stator 1. The stator 1 comprises a stack 12 of stator laminations, e.g. made of electrical steel or other soft magnetic steel. The stack 12 is annular in cross-section and has slots on its radial outer side, for example eighteen slots, in which electrically insulating inserts 13, for example made of paper or plastic, can be arranged. Between the slots, the stack 12 forms stator teeth directed radially outwards, which are surrounded by the stator windings 11.

End caps 14 are arranged at both axial ends of the stack 12. The end caps 14 have axial projections 14a, 14b, 14c, which form passages and wire guides for winding wire between them. The end caps 14 thus facilitate the correct wire routing between the individual windings 11 and the correct interconnection of the individual windings 11, in particular the three phases, and also serve to electrically insulate the phases from each other and from ground. In order to fulfil this task, the two end caps 14 must be correctly positioned and centred in relation to each other, in particular with regard to their rotational angle position and the resulting wire clearance between the stator teeth.

In order to achieve correct positioning of the two end caps 14, grooves 15a are arranged on a radial inner side of the sheet stack 12 in the embodiment shown. The end caps 14 have corresponding grooves 15b on their radial inner side, which, when assembled, continue the grooves 15a of the sheet stack 12. The grooves 15a, 15b run straight in the axial direction. A tool 20 shown in FIG. 4 is used for assembly, which has pins 21 that are first inserted into the grooves 15b of one of the two end caps 14, then into the grooves 15a of the sheet stack 12 and finally also into the grooves 15b of the other end cap 14. The pins 21 of the tool 20 thus ensure the angular positioning of the end caps 14 relative to each other and the centring with respect to the sheet stack 12. It is also possible to use the pins 21 to centre the end caps 14 in advance and then to achieve the position by means of axial preload.

In the embodiment shown, six grooves 15a and 15b are arranged equidistantly in the end caps 14 and in the sheet stack 12, respectively, and the tool 20 has six pins 21 accordingly. The end caps 14 have a corresponding six-fold rotational symmetry, i.e. a rotation of the end caps 14 relative to each other by 60° results in identical configurations. This symmetry is the same as the symmetry of the three-phase windings of the stator 1.

In the embodiment shown, the grooves 15a, 15b have a cross-section in the form of a circular segment to match the circular cross-section of the pins 21. For easy positioning of the end caps 14 and the sheet stack 12 relative to each other, it is sufficient for pins 21 with a circular cross-section if the grooves 15a, 15b have the shape of a circular segment in the area of their base, e.g. the grooves 15a, 15b may widen at a greater distance from their base.

In the embodiment shown, the depth of the grooves 15a, 15b in the radial direction is smaller than the radius of the circular segment and thus also smaller than the radius of the cross-section of the pins 21 in order to facilitate the positioning of the pins 21.

### LIST OF REFERENCE SYMBOLS

1 Stator
2 Rotor
2a Permanent magnet
3 Housing
4 Shaft
5 Control electronics
11 Stator winding
12 Sheet stack
13 Insert
14 End cap
14a Protrusion
14b Protrusion
14c Advantage
15a Groove
15b Groove
20 Tool
21 Pin

While this invention has been described as having an exemplary design, the present invention may be further modified within the spirit and scope of this disclosure. This application is therefore intended to cover any variations, uses, or adaptations of the invention using its general principles.

What is claimed is:

1. A three-phase external rotor motor, comprising:
a stator, and
a rotor surrounding the stator,
wherein the rotor comprises permanent magnets, and
the stator comprises a stack of sheet metal, end caps arranged at both ends of the stack and stator windings arranged in slots on a radial outer side of the stack, said stack having an annular cross-section, wherein the stator comprises grooves on a radial inner side, which run in a straight line in the axial direction from one of the two end caps over the sheet stack to the other end cap.

2. The three-phase external rotor motor according to claim 1, wherein the number of grooves on the inner side of the stator is an integer multiple of three and the grooves are evenly distributed in the circumferential direction.

3. The three-phase external rotor motor according to claim 1, wherein the stator has six grooves on its inner side.

4. The three-phase external rotor motor according to claim 1, wherein the grooves have the shape of a circular segment at least in the area of their base.

5. The three-phase external rotor motor according to claim 4, wherein the grooves in the end caps have a depth that is smaller than the radius of the circular segment.

6. The three-phase external rotor motor according to claim 1, wherein the stator has 18 slots.

7. A method for assembling a stator for a three-phase external rotor motor comprising:
stacking stator laminations to form a stack with an annular cross-section, which has grooves running in a straight line in the axial direction on a radial inner side,
attaching first and second end caps, which have grooves on a radial inner side, to the stack at both axial ends of the stack, wherein a tool having pins is used to attach the first and second end caps, wherein the pins are first inserted into the grooves of the first end cap and then inserted into the grooves of the stack to position the first end cap relative to the stack of the stack until these pins protrude from the end of the stack facing away from the tool, and then the second end cap is positioned on end of the sheet stack facing away from the tool by inserting the pins into the grooves of the second end cap, the tool is removed from the stator winding, and
windings are arranged in slots on the outside of the stack and the end caps.
